(19) United States
(12) Patent Application Publication
(10) Pub. No.: US 2024/0177046 A1
(43) Pub. Date: May 30, 2024

(54) Quantum Simulation Apparatus and Method Using Logical Qubit Synthesis

(71) Applicant: ELECTRONICS AND TELECOMMUNICATIONS RESEARCH INSTITUTE, Daejeon (KR)

(72) Inventors: Ki-Sung JIN, Iksan-si, Jeollabuk-do (KR); GYU-IL CHA, Daejeon (KR)

(73) Assignee: ELECTRONICS AND TELECOMMUNICATIONS RESEARCH INSTITUTE, Daejeon (KR)

(21) Appl. No.: 18/518,087

(22) Filed: Nov. 22, 2023

(30) Foreign Application Priority Data
Nov. 25, 2022 (KR) 10-2022-0160409
Sep. 5, 2023 (KR) 10-2023-0117472

(51) Int. Cl. G06N 10/80

(52) U.S. Cl. CPC G06N 10/80

(57) ABSTRACT

Disclosed herein are a quantum simulation apparatus and method using logical qubit synthesis. The quantum simulation apparatus is configured to generate a new virtual quantum device configured using magic qubits by dividing each logical qubit into multiple areas, extract logical qubit information from a target virtual quantum device that is a target of a logical Controlled NOT (CNOT) operation, synthesize the extracted logical qubit information into the new virtual quantum device, perform a logical CNOT operation in the synthesized virtual quantum device, extract logical qubit information from a result of the logical CNOT operation in the synthesized virtual quantum device, and synthesize the logical qubit information extracted from the result of the logical CNOT operation into the target virtual quantum device.

### CROSS REFERENCE TO RELATED APPLICATIONS

This application claims the benefit of Korean Patent Application Nos. 10-2022-0160409, filed Nov. 25, 2022 and 10-2023-0117472, filed Sep. 5, 2023, which are hereby incorporated by reference in their entireties into this application.

### BACKGROUND OF THE INVENTION

### 1. Technical Field

The present disclosure relates generally to quantum computer technology, and more particularly to quantum error correction technology and quantum simulation technology using logical qubit synthesis.

### 2. Description of the Related Art

A quantum computer is a future supercomputer based on quantum mechanics principles such as entanglement and superposition. As it is predicted that a quantum computer will be commercialized within 10 years, the quantum computer attracts attention as future technology that is capable of solving the problems that humanity has been unable to solve so far, such as new materials, new drug development, and space exploration. IBM became the first company to introduce quantum computing to the public cloud so that users can access quantum computers remotely, while Google reported to the scientific community that they achieved quantum supremacy in 2018 using a 54-qubit quantum processor called Sycamore.

However, basically, qubits correspond to a physical system based on quantum effects, and thus there always be the possibility that quantum mechanical error will occur during a qubit control process. Even in a situation in which no control signals are applied, quantum information stored in qubits may mutually interact with an external environment over time, and may then be transformed. Therefore, in order for a quantum algorithm to be reliably operated in quantum computing, techniques that are capable of protecting quantum information from errors that may occur in interaction with the external environment and in gate operations are essentially required.

Such a research field is referred to as “quantum error correction”, and a method in which an error correction scheme, which is classically frequently used, is applied to quantum information is proposed. According to this method, one piece of logical quantum information is distributed and stored in N physical qubits. Therefore, even though an error occurs in an arbitrary physical qubit, the original logical quantum information may be restored based on pieces of information held by the remaining qubits. Because topological quantum code represented by surface code has a high error threshold value, it is considerably attracting attention from the standpoint of quantum computing for enduring errors.

However, in the stage in which these quantum error correction techniques are realized using a classic computer, there is a fundamental obstacle to be overcome. The reason for this is due to the superposition effect of physical qubits, and thus a huge memory space having a size of 2^{N+4} bytes is required in order to represent N physical qubits by the computer. For example, a minimum memory requirement to simulate a quantum state composed of 60 physical qubits using the classic computer reaches 16 Exabytes. Due to these characteristics, it is known that, even though several thousands of existing supercomputers are used, it is realistically impossible to simulate a quantum circuit having 45 or more qubits.

Meanwhile, U.S. Patent Application Publication No. US2021/0132969 entitled “Quantum Virtual Machine for Simulation of a Quantum Processing System” discloses a Quantum Virtual Machine (QVM) for simulating a quantum circuit using a classical computer.

### SUMMARY OF THE INVENTION

Accordingly, the present disclosure has been made keeping in mind the above problems occurring in the prior art, and an object of the present disclosure is to apply a quantum error correction algorithm such as surface code using a classical digital computer.

Another object of the present disclosure is to remarkably decrease memory costs required for storing quantum states and to support a logical quantum operation of surface code without damaging original quantum information.

In accordance with an aspect of the present disclosure to accomplish the above objects, there is provided a quantum simulation apparatus using logical qubit synthesis, including one or more processors, and a memory configured to store at least one program that is executed by the one or more processors, wherein the at least one program is configured to generate a new virtual quantum device configured using magic qubits by dividing each logical qubit into multiple areas, extract logical qubit information from a target virtual quantum device that is a target of a logical Controlled NOT (CNOT) operation, synthesize the extracted logical qubit information into the new virtual quantum device, perform a logical CNOT operation in the synthesized virtual quantum device, extract logical qubit information from a result of the logical CNOT operation in the synthesized virtual quantum device, and synthesize the logical qubit information extracted from the result of the logical CNOT operation into the target virtual quantum device.

The new virtual quantum device may be configured such that each logical qubit is divided into multiple areas to contain logical qubit information in a local state.

The at least one program may be configured to synthesize the logical qubit information into the new virtual quantum device based on a quantum bit replacement method of replacing 2^{K} quantum state bits corresponding to local logical qubits and 2¹ quantum state bits corresponding to magic logical bits with each other.

The at least one program may be configured to perform the logical CNOT operation based on a lattice surgery provided by a surface code.

The at least one program may be configured to extract pieces of logical qubit information of an ancilla logical qubit, a target logical qubit, and a control logical qubit from the target virtual quantum device.

The at least one program may be configured to perform a merge_xx operation that enables the lattice surgery to be performed between the ancilla logical qubit and the target logical qubit in the synthesized virtual quantum device.

The at least one program may be configured to perform a merge_zz operation that enables the lattice surgery to be performed between the ancilla logical qubit, on which the merge_xx operation is performed, and the control logical qubit in the synthesized virtual quantum device.

The at least one program may be configured to extract logical qubit information of any one of the ancilla logical qubit and the control logical qubit and logical qubit information of the target logical qubit from the target virtual quantum device.

The at least one program may be configured to perform a merge_xx operation that enables the lattice surgery to be performed between the one logical qubit and the target logical qubit in the synthesized virtual quantum device.

The at least one program may be configured to perform a merge_zz operation that enables the lattice surgery to be performed between the one logical qubit, on which the merge_xx operation is performed, and a remaining one of the ancilla logical qubit and the control logical qubit in the synthesized virtual quantum device.

In accordance with another aspect of the present disclosure to accomplish the above objects, there is provided a quantum simulation method using logical qubit synthesis, the quantum simulation method being performed by a quantum simulation apparatus using logical qubit synthesis, the quantum simulation method including generating a new virtual quantum device configured using magic qubits by dividing each logical qubit into multiple areas, extracting logical qubit information from a target virtual quantum device that is a target of a logical Controlled NOT (CNOT) operation, synthesizing the extracted logical qubit information into the new virtual quantum device, performing a logical CNOT operation in the synthesized virtual quantum device, extracting logical qubit information from a result of the logical CNOT operation in the synthesized virtual quantum device, and synthesizing the logical qubit information extracted from the result of the logical CNOT operation into the target virtual quantum device.

The new virtual quantum device may be configured such that each logical qubit is divided into multiple areas to contain logical qubit information in a local state.

Synthesizing into the new virtual quantum device may include synthesizing the logical qubit information into the new virtual quantum device based on a quantum bit replacement method of replacing 2^{K} quantum state bits corresponding to local logical qubits and 2¹ quantum state bits corresponding to magic logical bits with each other.

Performing the logical CNOT operation may include performing the logical CNOT operation based on a lattice surgery provided by a surface code.

Extracting the logical qubit information from the target virtual quantum device may include extracting pieces of logical qubit information of an ancilla logical qubit, a target logical qubit, and a control logical qubit from the target virtual quantum device.

Performing the logical CNOT operation may include performing a merge_xx operation that enables the lattice surgery to be performed between the ancilla logical qubit and the target logical qubit in the synthesized virtual quantum device.

Performing the logical CNOT operation may further include performing a merge_zz operation that enables the lattice surgery to be performed between the ancilla logical qubit, on which the merge_xx operation is performed, and the control logical qubit in the synthesized virtual quantum device.

Extracting the logical qubit information from the target virtual quantum device may include extracting logical qubit information of any one of the ancilla logical qubit and the control logical qubit and logical qubit information of the target logical qubit from the target virtual quantum device.

Performing the logical CNOT operation may further include performing a merge_xx operation that enables the lattice surgery to be performed between the one logical qubit and the target logical qubit in the synthesized virtual quantum device.

Performing the logical CNOT operation may further include performing a merge_zz operation that enables the lattice surgery to be performed between the one logical qubit, on which the merge_xx operation is performed, and a remaining one of the ancilla logical qubit and the control logical qubit in the synthesized virtual quantum device.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating the configuration of logical qubits using a surface code 17 circuit according to an embodiment of the present disclosure;

FIG. 2 is a diagram illustrating a qubit configuration to which logical qubits are applied according to an embodiment of the present disclosure;

FIG. 3 is a diagram mathematically illustrating the logical quantum states of the qubits illustrated in FIG. 2;

FIG. 4 is a diagram illustrating individual logical quantum states represented by a logical qubit synthesis method according to an embodiment of the present disclosure;

FIG. 5 is a diagram mathematically illustrating individual logical quantum states represented by the logical qubit synthesis method illustrated in FIG. 4;

FIG. 6 is a diagram illustrating the configuration of quantum state bits in a virtual quantum device according to an embodiment of the present disclosure;

FIG. 7 is a diagram mathematically showing prediction of the amount of memory required by a single virtual quantum device when performing the representation of logical qubits, illustrated in FIG. 6, on a digital computer;

FIG. 8 is a diagram illustrating a single-qubit quantum operation based on a logical qubit synthesis method according to an embodiment of the present disclosure;

FIG. 9 is a diagram illustrating the concept of the synthesis and decomposition of logical quantum states according to an embodiment of the present disclosure;

FIG. 10 is a diagram illustrating diagram the synthesis of logical quantum states using quantum bit replacement according to an embodiment of the present disclosure;

FIGS. 11 to 13 are diagrams illustrating embodiments of CNOT based on the synthesis and decomposition of logical qubits according an embodiment of the present disclosure;

FIG. 14 is a diagram illustrating the application of multiple logical qubits using the synthesis and decomposition of logical qubits according to an embodiment of the present disclosure;

FIG. 15 is an operation flowchart illustrating a quantum simulation method using logical qubit synthesis according to an embodiment of the present disclosure;

FIG. 16 is an operation flowchart illustrating a quantum simulation method using logical qubit synthesis according to an embodiment of the present disclosure; and

FIG. 17 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, embodiments of the present disclosure will be described in detail with reference to the attached drawings.

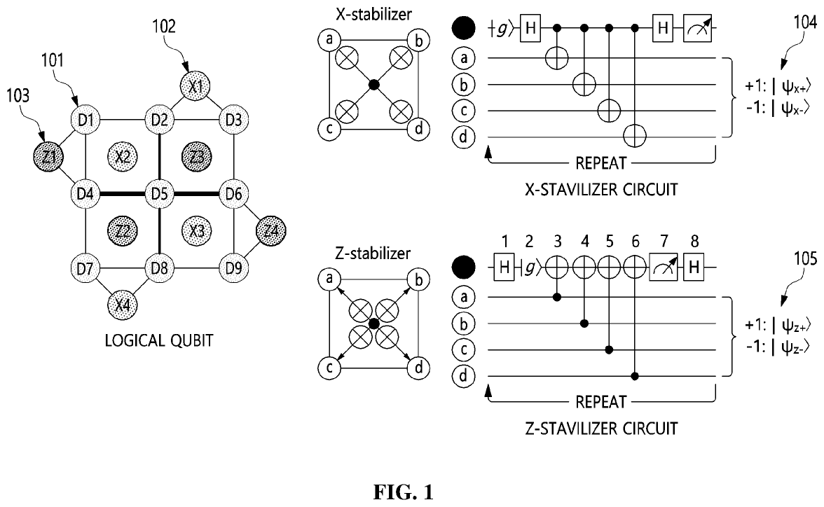

FIG. 1 is a diagram illustrating the configuration of logical qubits using a surface code 17 circuit according to an embodiment of the present disclosure.

Referring to FIG. 1, it can be seen that an example of a surface code 17 circuit for configuring one logical qubit by combining 17 physical qubits is illustrated. The arrangement of qubits on the left side of the drawing qubits represents the configuration of a single logical qubit. A total of 17 physical qubits, such as nine data qubits 101, four X-stabilizer qubits 102, and four Z-stabilizer qubits 103, are used. Each of reference numerals 104 and 105 denotes a special circuit for generating logical information in a stabilized state, and is referred to as a ‘stabilizer circuit’. When the stabilizer circuit is applied to each of stabilizer qubits, encoded logical quantum information (codeword) is assigned to the data qubits 101. When errors occur in individual data qubits, the detection and correction of the errors may be performed by tracking the changes in the states of the stabilizer qubits.

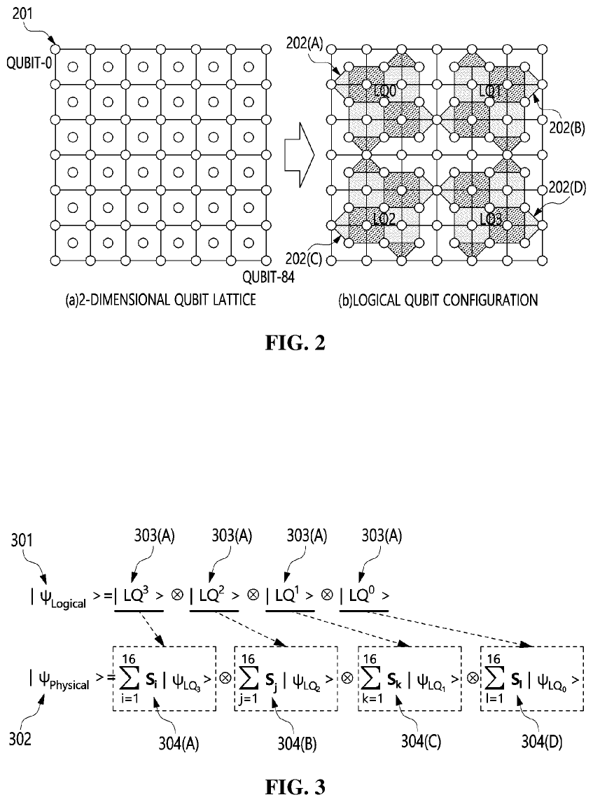

FIG. 2 is a diagram illustrating a qubit configuration to which logical qubits are applied according to an embodiment of the present disclosure.

Referring to FIG. 2. (a) shows the configuration of a two-dimensional (2D) quantum device composed of 85 physical qubits 201. The 2D quantum device is configured such that a qubit in the upper-left corner is set to a 0-th qubit, and the qubit number increases in a rightward direction and a downward direction. This is illustrated only for an example, and in an actual implementation stage, the present disclosure may be applied regardless of the number of physical qubits or the order mapping of qubits.

(b) shows an embodiment in which a logical qubit is configured by applying surface code 17 to the 2D quantum device in (a). It can be seen that one logical qubit is represented by combining 17 physical qubits. In other words, (b) shows that a total of four logical qubits 202(A) to 202(D) are configured in a qubit array composed of a total of 85 physical qubits, as shown in (a). The individual logical qubits may be used as data logical qubits in which quantum information is kept or as ancilla logical qubits to be utilized for quantum operations depending on the characteristics of a surface code algorithm.

FIG. 3 is a diagram mathematically illustrating the logical quantum states of the qubits illustrated in FIG. 2.

Referring to FIG. 3, a logical quantum state 301 may be represented by the tensor product of four logical qubits 302(A) to 302(D). Because each logical qubit may have two states |0_{L}> and |1₁>, which are logical quantum states, in a superposition thereof, the total number of logical quantum states that can be configured using four logical qubits may be 2⁴(16).

However, because the logical quantum states are abstracted representations in which the states of multiple physical qubits are combined, a physical quantum state composed of actual physical qubits may be represented by reference numeral 302. That is, each individual logical qubit may be initialized to the sum of the states of 16 stabilizers 304A to 304D with the application of the stabilizer circuit illustrated in FIG. 1. Here, the number of logical quantum states may be expanded to 2⁵(32) depending on a logical Hadamard operation. Because a logical quantum state may have a maximum of 2⁵(32) states for each logical qubit, a total of 2^{5*N} physical quantum states may be present assuming that there are N logical qubits, whereby memory for storing these states requires 2^{5*N+4} bytes. When this is converted into a memory requirement when represented by a digital computer, memory of 0.5TB is required even when there are only seven logical qubits, and thus the present disclosure may overcome the limitation of the number of representable logical qubits when a quantum error correction algorithm using surface code is executed on the digital computer.

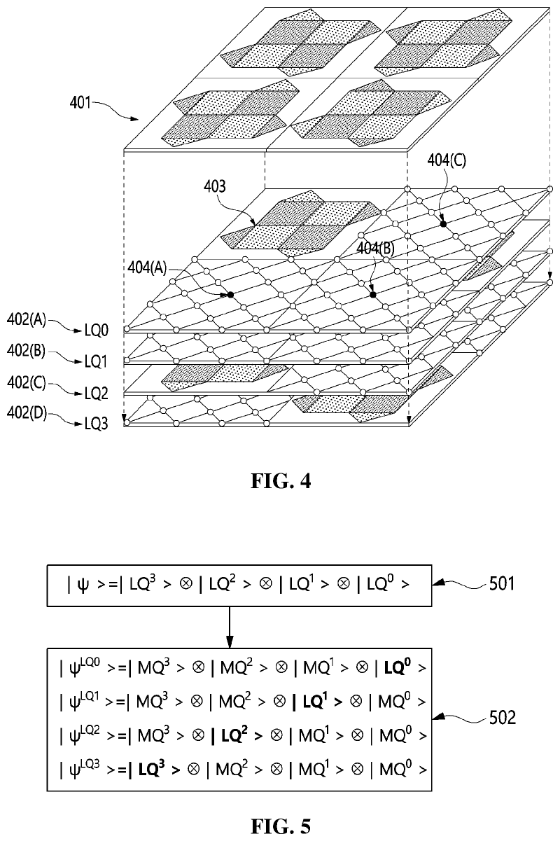

FIG. 4 is a diagram illustrating individual logical quantum states represented by a logical qubit synthesis method according to an embodiment of the present disclosure.

Referring to FIG. 4, it can be seen that a form in which, in order to represent multiple logical qubits at low lost on a digital computer, a quantum state is decomposed from the view of individual logical qubits in a local state is illustrated. A quantum device 401 having a total of 85 physical qubits is composed of four logical qubits. The logical or physical quantum state thereof may be represented by equations in FIG. 3. However, as described above, when quantum states are represented through the combination of all individual physical states, memory requirements exceed the memory limits of the digital computer. Accordingly, in order to overcome this situation, the logical quantum state of the quantum device 401 may be reconfigured to be decomposed into virtual quantum devices such as 402(A) to 402(D).

The virtual quantum devices 402(A) to 402(D) maintain the configuration of the quantum device equally having the 85 physical qubits without change, and may have the characteristic of reconfiguring the quantum device to preserve the locality of the individual logical qubits. Because the qubit configuration of the physical quantum device 401 is maintained without change, each virtual quantum device also has the characteristic of changing the states of the logical qubits only through a quantum operation on physical qubits.

As shown in FIG. 4, there are four logical qubits, and thus a total of four virtual quantum devices need to be provided. Each virtual quantum device may include two types of state information, that is, the physical state information of a logical qubit assigned thereto and the logical state information of the remaining logical qubits other than the logical qubit assigned thereto.

Reference numeral 403 denotes the physical state information of the logical qubit assigned to the relevant virtual quantum device itself. The quantum states stabilized by the above-described error correction code may be preserved without change, and the relevant quantum device may have 2⁴ or 2⁵ quantum states depending on whether a superposition of logical quantum states is present.

Reference numerals 404(A) to 404(C) represent the logical information of logical qubits other than the logical qubit assigned to the relevant virtual quantum device, excluding themselves, and have quantum states of |0_{L}> and |1_{L}>, or 2⁰ or 2¹ quantum states depending on whether a superposition of logical quantum states is present. In this case, information of the remaining logical qubits other than the logical qubit assigned to the relevant virtual quantum device is represented through one specific physical qubit, which may be referred to a magic qubit (each of 404(A) to 404(C)).

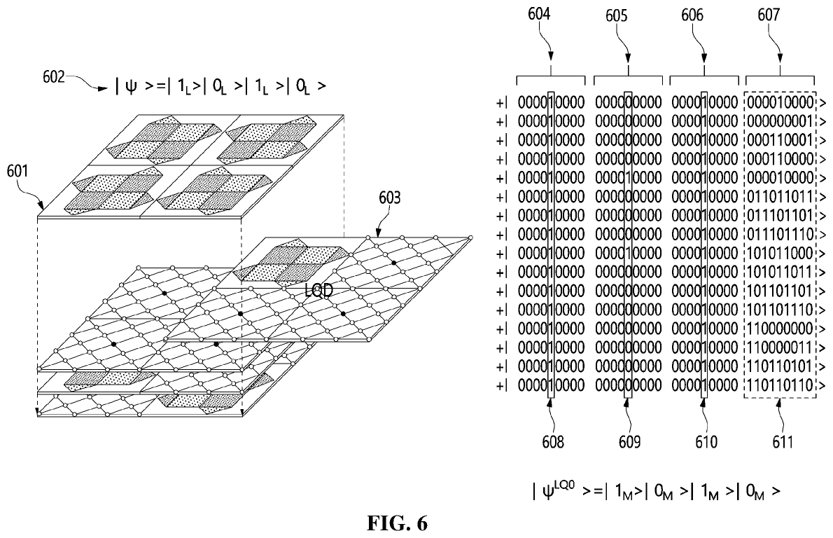

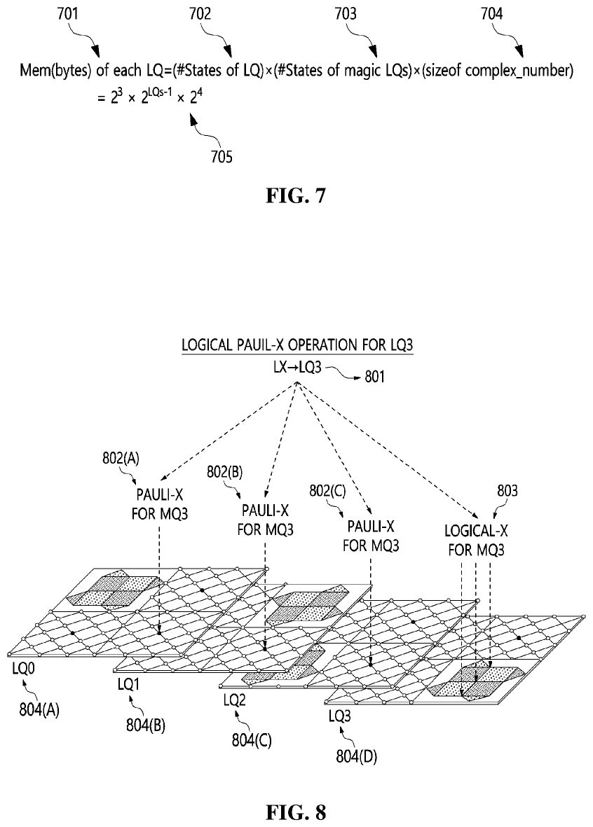

FIG. 5 is a diagram mathematically illustrating individual logical quantum states represented by the logical qubit synthesis method illustrated in FIG. 4.

Referring to FIG. 5, when logical qubit information is represented in the virtual quantum device, such as that shown in FIG. 4, the quantum state of each virtual quantum device is mathematically represented.

Reference numeral 501 denotes a quantum state represented in an original quantum device. Reference numeral 501 may show that logical states of four logical qubits are represented by a tensor product, and the actual physical states thereof may be identical to those in reference numeral 302 described in FIG. 3.

Reference numeral 502 shows that quantum states are represented in the virtual quantum devices in respective logical qubits. When a 0-th qubit is taken as an example, the state of the logical qubit assigned thereto may preserve and represent a maximum of 2⁵ quantum states without change, as in the case of |LQ⁰>, and for the remaining logical qubits, other than the relevant qubit itself, 2¹ pieces of logical quantum information may be configured through magic qubits, as in the case of |MQⁱ>.

According to the representation method of the virtual device such as 502, when there are N logical qubits, the number of quantum states required in each virtual quantum device is 2^{5+N}. It can be seen that, compared to 2^{5*N} states required in the conventional technique, the number of states is reduced depending on exponential features.

FIG. 6 is a diagram illustrating the configuration of quantum state bits in a virtual quantum device according to an embodiment of the present disclosure.

Referring to FIG. 6, reference numeral 601 denotes an original quantum device composed of four logical qubits, and logical quantum states thereof may be represented, as indicated by reference numeral 602.

Reference numeral 603 may be selected to exemplify quantum state bits in the virtual quantum device, and may correspond to the virtual quantum device of a 0-th logical qubit (LQ0).

The state bits present on the right side of the drawing represent, by way of example, only data logical qubits of surface code 17 described in FIG. 1, among 85 physical qubits assigned to the virtual quantum device of LQ0. Reference numerals 604, 605, 606, and 607 denote the quantum state bits of data logical qubits corresponding to LQ3, LQ2, LQ1, and LQ0, respectively.

Reference numeral 611 shows that all quantum states stabilized by the surface code of LQ0 are preserved and represented without change. Reference numeral 611 shows that the 0-th logical qubit has 2⁴(16) individual physical quantum states when initially stabilized and has 2⁵(32) individual physical quantum states when evolving into a logical superposition state through a logical Hadamard operation.

Reference numerals 608 to 610 correspond to magic qubits representing logical information of the remaining logical qubits LQ1 to LQ3 other than LQ0. According to the example of 602, LQ3 and LQ1 have a quantum state of |1> and LQ2 has a quantum state of |0>, and thus the magic qubits 608 and 610 may be represented by the quantum bit (qubit) state of |1> and the magic qubit 609 may be represented by the qubit state of |0>.

FIG. 7 is a diagram mathematically showing prediction of the amount of memory required by a single virtual quantum device when performing the representation of logical qubits, illustrated in FIG. 6, on a digital computer.

Referring to FIG. 7, a total memory (capacity) 701 that is entirely required may be calculated based on three conditions.

Reference numeral 702 denotes the number of physical states representing a logical qubit assigned to one virtual quantum device in the one virtual quantum device.

Reference numeral 703 denotes the number of physical states of magic qubits representing logical qubits, other than the logical qubit assigned to the one virtual quantum device, in the one virtual quantum device.

Reference numeral 704 denotes a complex value representing one physical state, and assumes a double precision size in the digital computer.

Memory usage required for representing one virtual quantum device may be obtained by multiplying the three conditions, and may be represented by reference numeral 705. Reference numerals 702 and 704 may be fixed values, and reference numeral 703 may dynamically vary depending on the number of logical qubits.

FIG. 8 is a diagram illustrating a single-qubit quantum operation based on a logical qubit synthesis method according to an embodiment of the present disclosure.

When any logical quantum operation is given, the present disclosure may maintain quantum states so that the quantum states of all virtual quantum devices are equally changed. In other words, even at any time point before or after the logical quantum operation is applied, the logical quantum states of the virtual quantum device need to be identical.

Referring to FIG. 8, it is assumed that a logical Pauli-X operation is applied to a third logical qubit LQ3, as indicated by reference numeral 801. In the present example, although the Pauli-X gate operation is illustrated as being applied as a single-qubit logical quantum operation, it is possible to apply all types of single-gate operations in the actual practice step of the present disclosure.

Meanwhile, a process of processing the logical Pauli-X operation may be broadly performed in two stages.

First, in the remaining virtual quantum devices 802(A) to 802(C) other than the virtual quantum device 803 of LQ3, a Pauli-X operation may be applied to physical qubits corresponding to the magic qubit of LQ3. Because the Pauli-X operation is performed on physical qubits in the same area in the virtual quantum devices having the same logical information, the logical states of LQ0, LQ1, and LQ2 may be maintained identically without change even after the operation is completed.

Second, a quantum operation may be applied to the virtual quantum device 803 to which LQ3 is assigned based on the processing rule of a logical operator defined by surface code. According to this process, because the Pauli-X operation is defined as being performed on three data qubits crossing X-stabilizer qubits, the Pauli-X operation may be applied to the three physical qubits corresponding to the three data qubits (803).

In the case of the single-logic gate operation as shown in FIG. 8, the processing of logical quantum operations is possible only by performing independent control at individual virtual quantum device levels depending on the locality of logical qubits.

However, the case of an operation in which multiple logical qubits are combined with each other, a technique for guaranteeing interaction between local logical qubits needs to be separately provided. In the present disclosure, this technique is called the synthesis and decomposition of logical quantum states.

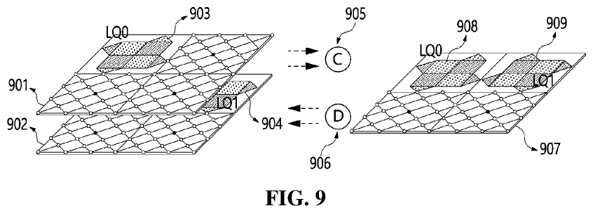

FIG. 9 is a diagram illustrating the concept of the synthesis and decomposition of logical quantum states according to an embodiment of the present disclosure.

Referring to FIG. 9, the concept of the synthesis and decomposition of pieces of logical qubit information stored in multiple virtual quantum devices is illustrated.

In accordance with the logical quantum synthesis and decomposition according to an embodiment of the present disclosure, in order to process an operation in which multiple qubits are combined with each other, the following procedure may be followed.

As illustrated in FIG. 9, two virtual quantum devices 901 and 902 are present, and pieces of local logical information of LQ0 903 and LQ1 904 may be assigned to the virtual quantum devices, respectively.

In a first stage, a new virtual quantum device 907 for the synthesis of the logical information of LQ0 and LQ1 may be prepared. In this case, in the new virtual quantum device, information of all logical qubits may be represented by magic logical qubits.

In a second stage, pieces of logical qubit information corresponding to LQ0 and LQ1 may be extracted from the original virtual quantum devices 901 and 902, and may be synthesized, and the synthesized information may be assigned to the new virtual quantum device (905). In this case, pieces of logical information represented by three virtual quantum devices may be identical to each other.

In a third stage, in the synthesized virtual quantum device, a logical operation based on a lattice surgery provided by surface code may be performed. Accordingly, logical quantum states of LQ0 and LQ1 may be transformed.

In a fourth stage, the synthesized logical qubit information may be decomposed into pieces of logical information of LQ0 and LQ1 depending on the logical operation of surface code, and may then be returned to the original virtual quantum devices 901 and 902, respectively (906).

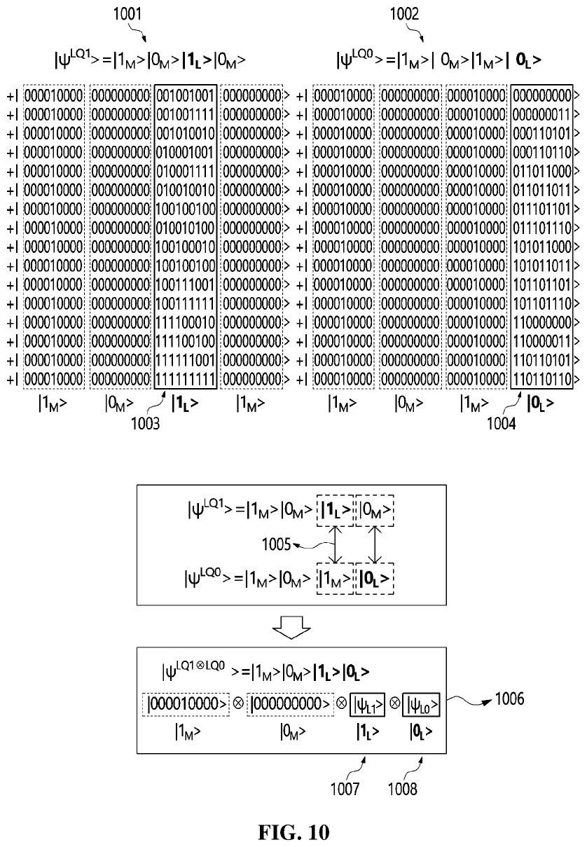

FIG. 10 is a diagram illustrating the synthesis of logical quantum states using quantum bit replacement according to an embodiment of the present disclosure.

Referring to FIG. 10, the logical quantum information synthesis process corresponding to the second stage of FIG. 9 is described from the standpoint of quantum bits.

FIG. 10 illustrates the synthesis of pieces of logical quantum information by selecting two logical qubits LQ1 and LQ0, but this is only an example, and the present disclosure is characterized in that, in an actual implementation stage, information synthesis between any logical qubits is possible. Further, in FIG. 10, the deposition process of restoring the synthesized quantum information to the original states is omitted, but decomposition may be performed in the reverse order of the synthesis process.

It can be seen that reference numeral 1001 denotes a combination of a logical quantum state and physical qubit states which correspond to LQ1. LQ3, LQ2, and LQ0 may represent logical information by the states of magic qubits. LQ1 may represent logical information by 16 physical qubit states 1003.

It can be seen that reference numeral 1002 denotes a combination of a logical quantum state and physical qubit states which correspond to LQ0. LQ3, LQ2, and LQ1 may represent logical information by the states of magic qubits. LQ0 may represent logical information by 16 physical qubit states 1004.

The present disclosure may mutually replace quantum bits to be targets with each other when pieces of logical quantum information are synthesized. The reason for this is that, in |Ψ^{LQ1} [symbol] and |Ψ^{LQ0} [symbol] having the same logical information, the states of magic qubits and the states of logical qubits have the same logical information, and thus the same logical information may be preserved even through quantum bits representing two states are mutually replaced with each other. As exemplified in reference numeral 1005, even though logical information in the same qubit region is replaced, logical quantum states of |Ψ^{LQ0} [symbol] and |Ψ^{LQ1} [symbol] always be |1010, and thus the equality of logical information may be guaranteed.

Reference numeral 1006 shows the result of synthesizing LQ1 and LQ0 through the quantum bit replacement method. Assuming that the synthesized virtual quantum device is |Ψ^{LQ⊗LQ0} [symbol] by way of example, the synthesized logical quantum state shows that components of LQ1 and LQ0 can be represented by logical qubits rather than magic qubits, as in the case of |1_{M} [symbol] ⊗|0_{M} [symbol] ⊗|1_{L} [symbol] ⊗|0_{L} [symbol] .

Because |ψ_{L1}, which is the component of LQ1, and |ψ_{L0}, which is the component of LQ0, each have 2⁴(16) physical states, and two logical states are represented by a tensor product, the number of quantum states of the synthesized logical quantum state |ψ^{LQ1⊗LQ0} [symbol] may be expanded up to 2⁸(2⁴×2⁴=256).

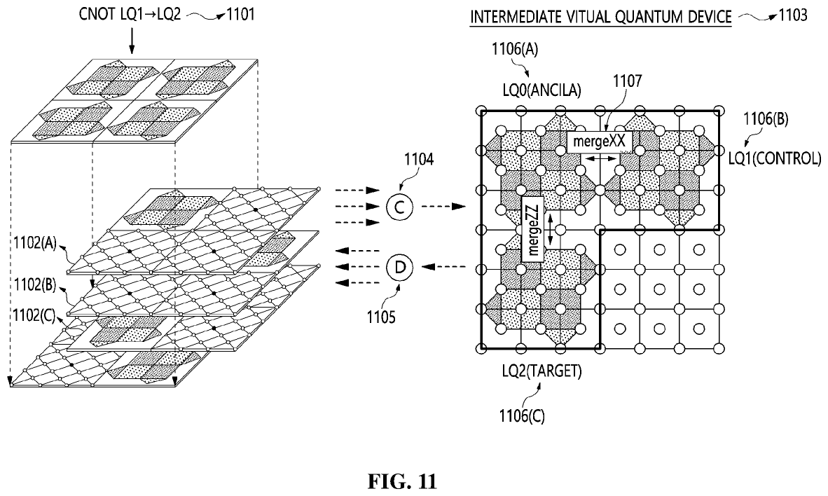

When the above-described logical qubit synthesis is used, a logical quantum operation between multiple logical qubits, such as a logical CNOT operation, may also be realized through virtual quantum devices. That is, after pieces of logical qubit information that are the targets of a logical CNOT operation are synthesized to generate a single quantum state space, the logical CNOT operation may be performed in the synthesized state, and the result thereof may be restored to the original logical qubit information. A detailed method supporting this process may be implemented using three methods of FIGS. 11 to 13. The three methods are different from each other in the implementation process, but they calculate the same logical qubit information, thus allowing the practitioner of the present disclosure to select a suitable method from among the methods from the standpoint of system configuration or processing cost and to use the selected method.

FIGS. 11 to 13 are diagrams illustrating embodiments of CNOT based on the synthesis and decomposition of logical qubits according an embodiment of the present disclosure.

Referring to FIG. 11, a first embodiment of a logical Controlled-NOT (CNOT) operation using the synthesis, operation and decomposition of logical qubits is depicted.

The first embodiment shows a CNOT operation that uses LQ1 as a control logical qubit and uses LQ2 as a target logical qubit.

A logical CNOT operation on LQ1 and LQ2 does not mean a CNOT operation performed in units of a single physical qubit, but may conform to a lattice surgery method proposed by surface code. According to this, in addition to the logical qubit that is the target of operation, a logical qubit which is an ancilla may be required, and LQ0 may be used as an ancilla logical qubit for the lattice surgery. That is, for the logical CNOT operation, three pieces of logical qubit information corresponding to LQ0. LQ1, and LQ2 may be required, and virtual quantum devices corresponding to respective logical qubits may be indicated by 1102(A) to 1102(C).

The procedure of the first logical CNOT operation using the synthesis, operation, and decomposition of the logical qubits illustrated in FIG. 11 may be described as follows.

The present disclosure may generate a new virtual quantum device 1103 to be temporarily utilized to contain the synthesized information of logical qubits. The new virtual quantum device may be a space for realizing the synthesis and operation of logical qubit information, and may be removed after the logical information of the operation result is returned to the original virtual quantum device. The new virtual quantum device may represent all pieces of logical qubit information through magic qubits.

Furthermore, the present disclosure may extract the pieces of logical information of LQ0, LQ1, and LQ2 from the virtual quantum devices 1102(A) to 1102(C), and may substitute the extracted logical information into the magic qubit areas of the temporary (intermediate) virtual quantum device.

In detail, the logical information of LQ0 may be substituted into 1106(A), the logical information of LQ1 may be substituted into 1106(B), and the logical information of LQ2 may be substituted into 1106(C).

The present disclosure may represent only an area corresponding to LQ3 among the pieces of information of the virtual quantum device by a magic qubit, and LQ0, LQ1, and LQ2, other than LQ3, may have complete logical qubit information. When this is mathematically represented, |Ψ^{new} [symbol] =1_{M}0_{L}1_{L}0_{L} [symbol] may be obtained, and the total number of physical quantum states may be 2¹²(4,096).

Furthermore, the present disclosure may apply a logical CNOT operation in surface code.

Here, the present disclosure may perform a lattice surgery through a merge_xx operation 1107 between an ancilla logical qubit 1106A and a target logical qubit 1106B in a synthesized space 1103, and thereafter apply a merge_zz operation 1108 between the logical qubit 1106A and a control logical qubit 1106C.

Furthermore, after the logical CNOT operation is completed, the present disclosure may extract only pieces of quantum bit information of LQ0, LQ1, and LQ2 from the synthesized virtual quantum device (i.e., intermediate virtual quantum device) 1103 and substitute the pieces of quantum bit information into the original virtual quantum devices 1102(A) to 1102(C), respectively (1105).

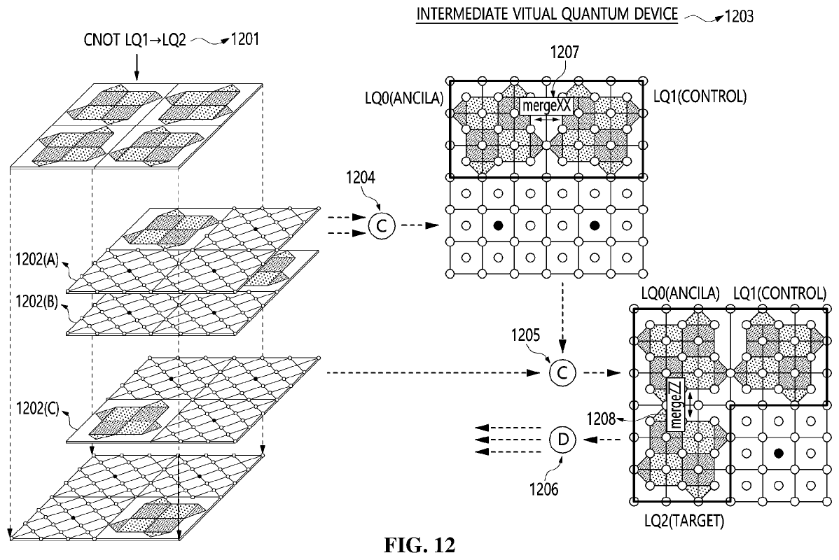

Referring to FIG. 12, a second embodiment of a logical CNOT operation using the synthesis, operation and decomposition of logical qubits is depicted. In FIG. 11, three pieces of logical qubit information on which the logical CNOT operation is to be performed are simultaneously synthesized, whereas, in FIG. 12, pieces of logical qubit information may be dynamically synthesized depending on the time at which a lattice surgery is performed. Detailed stages thereof will be described below.

First, the present disclosure may generate a new virtual quantum device 1203 by synthesizing pieces of logical qubit information of an ancilla logical qubit 1202A and a target logical qubit 1202B (1204).

Also, the present disclosure may apply a lattice surgery through a merge_xx operation 1207 between the ancilla logical qubit and the target logical qubit in the synthesized virtual quantum device (i.e., intermediate virtual quantum device).

Further, the present disclosure may extract the logical qubit information of a control logical qubit 1202C, and may synthesize the extracted information into the virtual quantum device on which the merge_xx operation has been completed (1205).

Also, the present disclosure may apply a lattice surgery through a merge_xx operation 1208 between the ancilla logical qubit and the control logical qubit in the synthesized virtual quantum device (i.e., intermediate virtual quantum device).

Furthermore, after the logical CNOT operation is completed, the present disclosure may extract only pieces of quantum bit information of LQ0, LQ1, and LQ2 from the synthesized virtual quantum device (i.e., intermediate virtual quantum device) 1203 and substitute the pieces of quantum bit information into the original virtual quantum devices 1202(A) to 1202(C), respectively (1206).

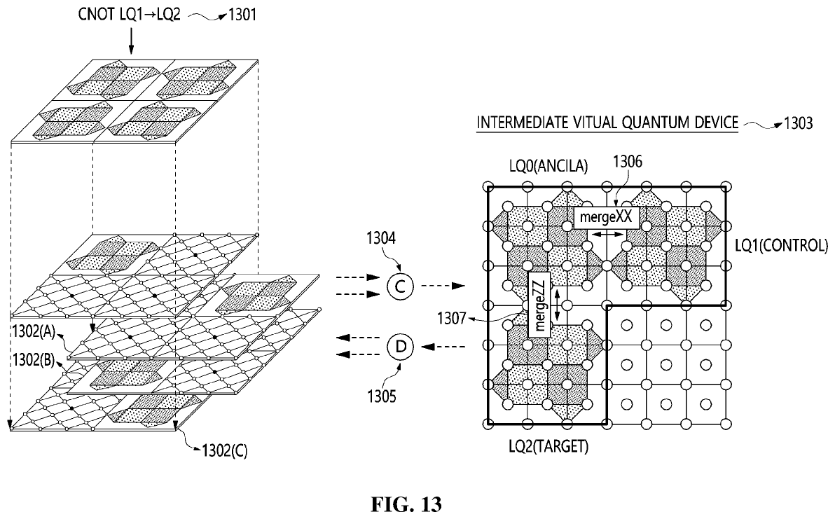

Referring to FIG. 13, a third embodiment of a logical CNOT operation using the synthesis, operation and decomposition of logical qubits is depicted. Unlike the example in which the synthesis of pieces of logical qubit information of three virtual quantum devices is required for the lattice surgery of FIGS. 11 and 12, FIG. 13 shows an example in which pieces of information of only a target logical qubit 1302A and a control logical qubit 1302B can be used for the synthesis and decomposition of quantum bits. The reason for this is that an ancilla logical qubit is not only always initialized immediately before a lattice surgery, but also temporarily used for a logical CNOT operation. Therefore, even though only two logical qubits 1302A and 1302B that are direct targets of the logical CNOT operation are used, the logical quantum information of data qubits may be completely preserved.

First, the present disclosure may generate a new virtual quantum device 1303 by synthesizing pieces of logical qubit information of an ancilla logical qubit 1302A and the target logical qubit 1302B (1304).

Further, the present disclosure may perform a lattice surgery through a merge_xx operation 1306 between the ancilla logical qubit and the target logical qubit in a synthesized space, and thereafter apply a merge_zz operation 1307 between the ancilla logical qubit and the control logical qubit.

Furthermore, after the logical CNOT operation is completed, the present disclosure may extract only pieces of quantum bit information of the target logical qubit LQ1 and the control logical qubit LQ2 from the synthesized virtual quantum device 1303 and substitute the pieces of quantum bit information into the original virtual quantum devices 1302(A) to 1302(C) (1305).

However, the above-described examples using four logical qubits are intended to simplify and explain the gist of the present disclosure, and possible logical qubits may be expanded to multiple logical qubits within the limited range of the memory mounted on the digital computer in the actual implementation stage.

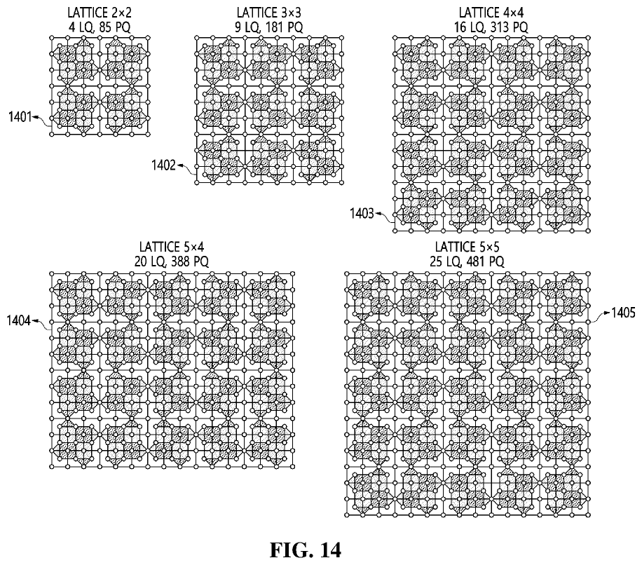

FIG. 14 is a diagram illustrating the application of multiple logical qubits using the synthesis and decomposition of logical qubits according to an embodiment of the present disclosure.

Referring to FIG. 14, the shapes (configurations) of a quantum device that can be applied in various forms according to the present disclosure are illustrated. The number of qubits that can be implemented and a memory capacity that is required when the configuration of each quantum device is represented on a digital computer may be represented, as shown in Table 1.

TABLE 1

| | Number of | Number of | Required | |
|---|---|---|---|---|
| Quantum device | physical qubits | logical qubits | memory | |
| 1401 of FIG. 14 | 85 | 4 | 16 | KB |
| 1402 of FIG. 14 | 181 | 9 | 1 | MB |
| 1403 of FIG. 14 | 313 | 16 | 256 | GB |
| 1404 of FIG. 14 | 388 | 20 | 5 | GB |
| 1405 of FIG. 14 | 481 | 25 | 200 | GB |

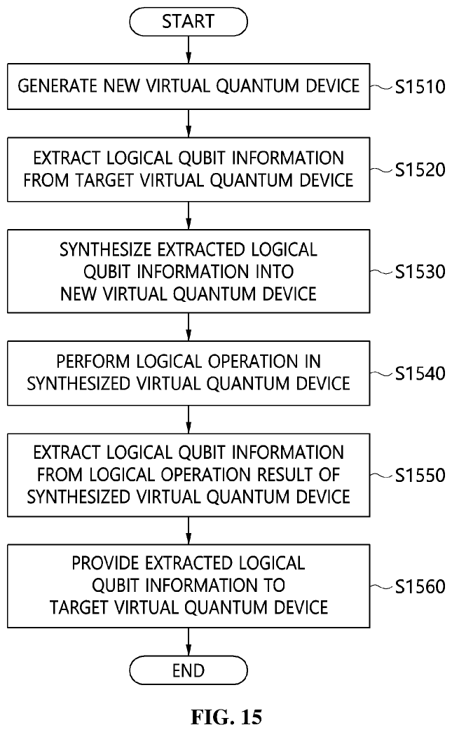

FIG. 15 is an operation flowchart illustrating a quantum simulation method using logical qubit synthesis according to an embodiment of the present disclosure.

Referring to FIG. 15, the quantum simulation method using logical qubit synthesis according to the embodiment of the present disclosure may generate a new virtual quantum device at step S1510.

That is, at step S1510, in order to contain logical qubit information in a local state, each logical qubit may be divided into multiple areas, and thus a new virtual quantum device composed of magic qubits may be generated.

The logical qubit information may include the physical state information of the logical qubit assigned to the virtual quantum device and the logical state information of logical qubits of virtual quantum devices, other than the virtual quantum device.

The information of the logical qubits other than the logical qubit assigned to the relevant virtual quantum device may correspond to a physical qubit represented by one specific physical qubit, and may be the magic qubit.

The new virtual quantum device may be a space for realizing the synthesis and operation of logical qubit information, and may be removed after the logical information of an operation result is returned to the original virtual quantum device.

In this case, in the new virtual quantum device, information of all logical qubits may be represented by magic logical qubits.

Further, the present disclosure may extract logical qubit information from a target virtual quantum device that is the target of a logical CNOT operation at step S1520.

The target virtual quantum device may include pieces of logical qubit information of an ancilla logical qubit, a target logical qubit, and a control logical qubit.

That is, at step S1520, the pieces of logical qubit information of the ancilla logical qubit, the target logical qubit, and the control logical qubit may be extracted from the target virtual quantum device.

Furthermore, the present disclosure may synthesize the logical qubit information extracted from the target virtual quantum device into the new virtual quantum device at step S1530.

That is, at step S1530, the extracted logical qubit information of the ancilla logical qubit, the target logical qubit, and the control logical qubit may be substituted into the magic qubit areas of the new virtual quantum device.

Here, at step S1530, the pieces of logical qubit information may be synthesized using a quantum bit replacement method of replacing 2^{k} quantum state bits corresponding to local logical qubits and 2¹ quantum state bits corresponding to the magic logical qubits with each other.

Furthermore, the present disclosure may perform a logical CNOT operation in the synthesized virtual quantum device at step S1540.

That is, at step S1540, in the synthesized virtual quantum device, a logical CNOT operation based on a lattice surgery provided by surface code may be performed.

Here, at step S1540, in the synthesized virtual quantum device, a lattice surgery may be performed through a merge_xx operation between the ancilla logical qubit and the target logical qubit.

Here, at step S1540, a merge_zz operation between the ancilla logical qubit and the control logical qubit may be performed.

Accordingly, the logical quantum state of the logical qubit information may be transformed.

Furthermore, the present disclosure may extract logical qubit information from the result of the logical CNOT operation in the synthesized virtual quantum device at step S1550.

That is, at step S1550, after the logical CNOT operation is completed, only the logical qubit information may be extracted from the synthesized virtual quantum device.

Furthermore, the present disclosure may synthesize the extracted logical qubit information into the target virtual quantum device at step S1560.

That is, at step S1560, the extracted logical qubit information may be provided to the original virtual quantum device, and pieces of logical qubit information may be substituted into respective virtual quantum devices.

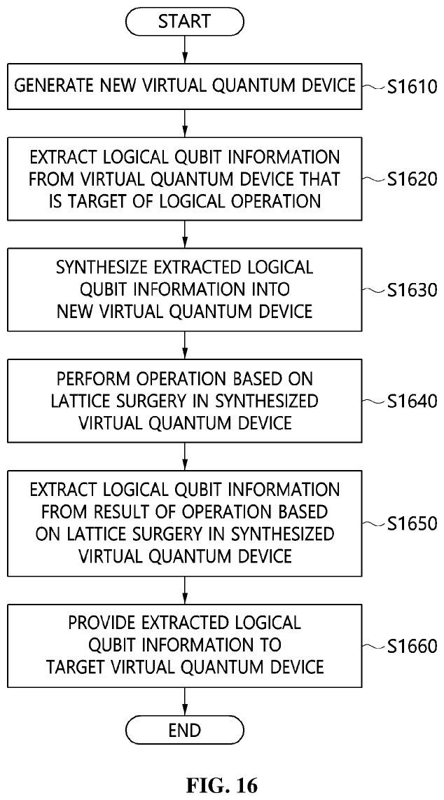

FIG. 16 is an operation flowchart illustrating a quantum simulation method using logical qubit synthesis according to an embodiment of the present disclosure.

Referring to FIG. 16, the quantum simulation method using logical qubit synthesis according to the embodiment of the present disclosure may generate a new virtual quantum device at step S1610.

That is, at step S1610, in order to contain logical qubit information in a local state, each logical qubit may be divided into multiple areas, and thus a new virtual quantum device composed of magic qubits may be generated.

The logical qubit information may include the physical state information of the logical qubit assigned to the virtual quantum device and the logical state information of logical qubits of virtual quantum devices, other than the virtual quantum device.

The information of the logical qubits other than the logical qubit assigned to the relevant virtual quantum device may correspond to a physical qubit represented by one specific physical qubit, and may be the magic qubit.

The new virtual quantum device may be a space for realizing the synthesis and operation of logical qubit information, and may be removed after the logical information of an operation result is returned to the original virtual quantum device.

In this case, in the new virtual quantum device, information of all logical qubits may be represented by magic logical qubits.

Further, the present disclosure may extract logical qubit information from a target virtual quantum device that is the target of a logical CNOT operation at step S1620.

The target virtual quantum device may include pieces of logical qubit information of an ancilla logical qubit, a target logical qubit, and a control logical qubit.

That is, at step S1620, the pieces of logical qubit information of the ancilla logical qubit and the target logical qubit may be extracted from the target virtual quantum device.

Furthermore, the present disclosure may synthesize the logical qubit information extracted from the target virtual quantum device into the new virtual quantum device at step S1630.

That is, at step S1630, the extracted logical qubit information of any one of the ancilla logical qubit and the control logical qubit and the logical qubit information of the target logical qubit may be substituted into the magic qubit areas of the new virtual quantum device.

Here, at step S1630, the pieces of logical qubit information may be synthesized using a quantum bit replacement method of replacing 2^{K} quantum state bits corresponding to local logical qubits and 2¹ quantum state bits corresponding to the magic logical qubits with each other.

Furthermore, the present disclosure may perform a logical CNOT operation in the synthesized virtual quantum device at step S1640.

That is, at step S1640, in the synthesized virtual quantum device, a logical CNOT operation based on a lattice surgery provided by surface code may be performed.

Here, at step S1640, in the synthesized virtual quantum device, a lattice surgery may be performed through a merge_xx operation between the one logical qubit and the target logical qubit.

In this case, at step S1640, the logical qubit information of the other of the ancilla logical qubit and the control logical qubit may be extracted from the target virtual quantum device.

In this case, at step S1640, the extracted logical qubit information of the other logical qubit may be substituted into the magic qubit area of the new virtual quantum device.

In this case, at step S1640, a merge_zz operation may be performed between the one logical qubit, on which the merge_xx operation has been performed, and the other logical qubit.

Accordingly, the logical quantum state of the logical qubit information may be transformed.

Furthermore, the present disclosure may extract logical qubit information from the result of the logical CNOT operation in the synthesized virtual quantum device at step S1650.

That is, at step S1650, after the logical CNOT operation is completed, only the logical qubit information may be extracted from the synthesized virtual quantum device.

Furthermore, the present disclosure may synthesize the extracted logical qubit information into the target virtual quantum device at step S1660.

That is, at step S1660, the extracted logical qubit information may be provided to the original virtual quantum device, and pieces of logical qubit information may be substituted into respective virtual quantum devices.

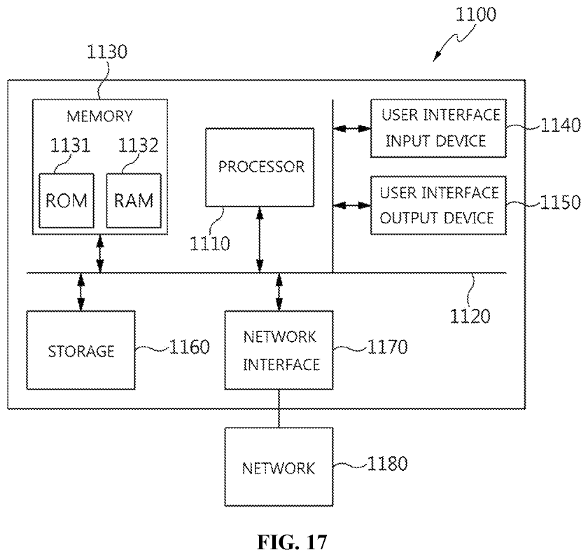

FIG. 17 is a diagram illustrating a computer system according to an embodiment of the present disclosure.

Referring to FIG. 17, a quantum simulation apparatus using logical qubit synthesis according to embodiments of the present disclosure may be implemented in a computer system 1100 such as a computer-readable storage medium. As illustrated in FIG. 13, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

A quantum simulation apparatus using logical qubit synthesis according to an embodiment of the present disclosure may include one or more processors 1110 and memory 1130 configured to store at least one program that is executed by the one or more processors 1110, wherein the at least one program is configured to generate a new virtual quantum device configured using magic qubits by dividing each logical qubit into multiple areas, extract logical qubit information from a target virtual quantum device that is a target of a logical Controlled NOT (CNOT) operation, synthesize the extracted logical qubit information into the new virtual quantum device, perform a logical CNOT operation in the synthesized virtual quantum device, extract logical qubit information from a result of the logical CNOT operation in the synthesized virtual quantum device, and synthesize the logical qubit information extracted from the result of the logical CNOT operation into the target virtual quantum device.

Here, the new virtual quantum device may be configured such that each logical qubit is divided into multiple areas to contain logical qubit information in a local state.

Here, the at least one program may be configured to synthesize the logical qubit information into the new virtual quantum device based on a quantum bit replacement method of replacing 2^{K} quantum state bits corresponding to local logical qubits and 2¹ quantum state bits corresponding to magic logical bits with each other.

Here, the at least one program may be configured to perform the logical CNOT operation based on a lattice surgery provided by a surface code.

Here, the at least one program may be configured to extract pieces of logical qubit information of an ancilla logical qubit, a target logical qubit, and a control logical qubit from the target virtual quantum device.

Here, the at least one program may be configured to perform a merge_xx operation that enables the lattice surgery to be performed between the ancilla logical qubit and the target logical qubit in the synthesized virtual quantum device.

Here, the at least one program may be configured to perform a merge_zz operation that enables the lattice surgery to be performed between the ancilla logical qubit, on which the merge_xx operation is performed, and the control logical qubit in the synthesized virtual quantum device.

Here, the at least one program may be configured to extract logical qubit information of any one of the ancilla logical qubit and the control logical qubit and logical qubit information of the target logical qubit from the target virtual quantum device.

Here, the at least one program may be configured to perform a merge_xx operation that enables the lattice surgery to be performed between the one logical qubit and the target logical qubit in the synthesized virtual quantum device.

Here, the at least one program may be configured to perform a merge_zz operation that enables the lattice surgery to be performed between the one logical qubit. on which the merge_xx operation is performed, and a remaining one of the ancilla logical qubit and the control logical qubit in the synthesized virtual quantum device.

Further, the quantum simulation apparatus and method using logical qubit synthesis according to an embodiment of the present disclosure may be configured to, when logical qubits having topological quantum code such as surface code are simulated using a classical computer, assign unique virtual quantum devices which preserve the local state information of logical qubits to respective logical qubits, instead of representing logical information of all logical qubits forming a quantum device by one quantum state space, thus computer-simulating the states of a larger number of logical qubits and logical quantum operations with less memory resources while completely representing all global logical quantum states.

Furthermore, the quantum simulation apparatus and method using logical qubit synthesis according to an embodiment of the present disclosure may maintain a number of virtual quantum devices identical to the number of logical qubits, and may represent the physical state information of a logical qubit assigned to each of the virtual quantum devices and the logical information of other logical qubits by one physical qubit, for each virtual quantum device.

Furthermore, the quantum simulation apparatus and method using logical qubit synthesis according to an embodiment of the present disclosure may be configured to, when the quantum bits of virtual quantum devices are simulated using a digital computer, maintain, in principle, a number of quantum bits identical to the total number of physical qubits for each virtual quantum device. Assuming that the maximum number of quantum states that can be defined depending on stabilizer code in surface code is defined as 2^{K}, 2^{K} stabilized quantum bits may be assigned to the state information of logical qubits assigned to the virtual quantum devices, and one of physical data qubits assigned to each logical qubit may be selected and called a magic qubit for the remaining logical qubits, wherein only 2¹ pieces of logical information may be assigned to the corresponding magic qubit.

Furthermore, the quantum simulation apparatus and method using logical qubit synthesis according to an embodiment of the present disclosure may be configured such that, in order to predict memory requirements when the quantum bits of virtual quantum devices are simulated using a digital computer, if defining the number of logical qubits as N and the number of stabilized quantum states for each logical qubit as 2^{K}, and the magnitude of a complex number representing the probability amplitude of individual quantum states as 2⁴, the memory requirement (bytes) for each individual virtual quantum device may be represented by the following Equation (1), and the total memory requirement (bytes) may be represented by the following Equation (2).

memory requirement for each individual virtual quantum device (bytes)=2^{K}×2^{N-1}×2⁴ (1)

total memory requirement (bytes)=(memory requirement for each individual virtual quantum device)×N (2)

Furthermore, the quantum simulation apparatus and method using logical qubit synthesis according to an embodiment of the present disclosure may mathematically model a virtual quantum device by a tensor product of |Ψ^{LQ}> representing local 2^{N} physical states of a logical qubit and |Ψ^{MQ}> representing 2¹ magic qubit states.

Furthermore, the quantum simulation apparatus and method using logical qubit synthesis according to an embodiment of the present disclosure are advantageous in that they may overcome the technical limitation of the conventional technology in that only two logical qubits are supported, and in that 20 or more logical qubits may be operated in a single computing environment. Ideas contrived from the present disclosure may be combined, as individual element technologies, with existing classical quantum simulation apparatuses, and may be implemented in the form of a completed quantum simulator when the ideas are integrated and configured.

The present disclosure may apply a quantum error correction algorithm such as surface code using a classical digital computer.

Further, the present disclosure may remarkably decrease memory costs required for storing quantum states, and may support a logical quantum operation of surface code without damaging original quantum information.

As described above, in the quantum simulation apparatus and method using logical qubit synthesis according to the present disclosure, the configurations and schemes in the above-described embodiments are not limitedly applied, and some or all of the above embodiments can be selectively combined and configured such that various modifications are possible.

What is claimed is:

1. A quantum simulation apparatus using logical qubit synthesis, comprising:
one or more processors; and
a memory configured to store at least one program that is executed by the one or more processors,
wherein the at least one program is configured to:
generate a new virtual quantum device configured using magic qubits by dividing each logical qubit into multiple areas,
extract logical qubit information from a target virtual quantum device that is a target of a logical Controlled NOT (CNOT) operation,
synthesize the extracted logical qubit information into the new virtual quantum device,
perform a logical CNOT operation in the synthesized virtual quantum device,
extract logical qubit information from a result of the logical CNOT operation in the synthesized virtual quantum device, and
synthesize the logical qubit information extracted from the result of the logical CNOT operation into the target virtual quantum device.

2. The quantum simulation apparatus of claim 1, wherein the new virtual quantum device is configured such that each logical qubit is divided into multiple areas to contain logical qubit information in a local state.

3. The quantum simulation apparatus of claim 1, wherein the at least one program is configured to synthesize the logical qubit information into the new virtual quantum device based on a quantum bit replacement method of replacing 2^{K} quantum state bits corresponding to local logical qubits and 2¹ quantum state bits corresponding to magic logical bits with each other.

4. The quantum simulation apparatus of claim 2, wherein the at least one program is configured to perform the logical CNOT operation based on a lattice surgery provided by a surface code.

5. The quantum simulation apparatus of claim 4, wherein the at least one program is configured to extract pieces of logical qubit information of an ancilla logical qubit, a target logical qubit, and a control logical qubit from the target virtual quantum device.

6. The quantum simulation apparatus of claim 5, wherein the at least one program is configured to perform a merge_xx operation that enables the lattice surgery to be performed between the ancilla logical qubit and the target logical qubit in the synthesized virtual quantum device.

7. The quantum simulation apparatus of claim 6, wherein the at least one program is configured to perform a merge_zz operation that enables the lattice surgery to be performed between the ancilla logical qubit, on which the merge_xx operation is performed, and the control logical qubit in the synthesized virtual quantum device.

8. The quantum simulation apparatus of claim 4, wherein the at least one program is configured to extract logical qubit information of any one of the ancilla logical qubit and the control logical qubit and logical qubit information of the target logical qubit from the target virtual quantum device.

9. The quantum simulation apparatus of claim 8, wherein the at least one program is configured to perform a merge_xx operation that enables the lattice surgery to be performed between the one logical qubit and the target logical qubit in the synthesized virtual quantum device.

10. The quantum simulation apparatus of claim 9, wherein the at least one program is configured to perform a merge_zz operation that enables the lattice surgery to be performed between the one logical qubit, on which the merge_xx operation is performed, and a remaining one of the ancilla logical qubit and the control logical qubit in the synthesized virtual quantum device.

11. A quantum simulation method using logical qubit synthesis, the quantum simulation method being performed by a quantum simulation apparatus using logical qubit synthesis, the quantum simulation method comprising:
generating a new virtual quantum device configured using magic qubits by dividing each logical qubit into multiple areas;
extracting logical qubit information from a target virtual quantum device that is a target of a logical Controlled NOT (CNOT) operation;
synthesizing the extracted logical qubit information into the new virtual quantum device;
performing a logical CNOT operation in the synthesized virtual quantum device;
extracting logical qubit information from a result of the logical CNOT operation in the synthesized virtual quantum device; and
synthesizing the logical qubit information extracted from the result of the logical CNOT operation into the target virtual quantum device.

12. The quantum simulation method of claim 11, wherein the new virtual quantum device is configured such that each logical qubit is divided into multiple areas to contain logical qubit information in a local state.

13. The quantum simulation method of claim 11, wherein synthesizing into the new virtual quantum device comprises:
synthesizing the logical qubit information with the new virtual quantum device based on a quantum bit replacement method of replacing 2^{K} quantum state bits corresponding to local logical qubits and 2¹ quantum state bits corresponding to magic logical bits with each other.

14. The quantum simulation method of claim 12, wherein performing the logical CNOT operation comprises:
performing the logical CNOT operation based on a lattice surgery provided by a surface code.

15. The quantum simulation method of claim 14, wherein extracting the logical qubit information from the target virtual quantum device comprises:
extracting pieces of logical qubit information of an ancilla logical qubit, a target logical qubit, and a control logical qubit from the target virtual quantum device.

16. The quantum simulation method of claim 15, wherein performing the logical CNOT operation comprises:
performing a merge_xx operation that enables the lattice surgery to be performed between the ancilla logical qubit and the target logical qubit in the synthesized virtual quantum device.

17. The quantum simulation method of claim 16, wherein performing the logical CNOT operation further comprises:
performing a merge_zz operation that enables the lattice surgery to be performed between the ancilla logical qubit, on which the merge_xx operation is performed, and the control logical qubit in the synthesized virtual quantum device.

18. The quantum simulation method of claim 14, wherein extracting the logical qubit information from the target virtual quantum device comprises:
extracting logical qubit information of any one of the ancilla logical qubit and the control logical qubit and logical qubit information of the target logical qubit from the target virtual quantum device.

19. The quantum simulation method of claim 18, wherein performing the logical CNOT operation further comprises:
performing a merge_xx operation that enables the lattice surgery to be performed between the one logical qubit and the target logical qubit in the synthesized virtual quantum device.

20. The quantum simulation method of claim 19, wherein performing the logical CNOT operation further comprises:
performing a merge_zz operation that enables the lattice surgery to be performed between the one logical qubit, on which the merge_xx operation is performed, and a remaining one of the ancilla logical qubit and the control logical qubit in the synthesized virtual quantum device.
